(19) United States
(12) Patent Application Publication
(10) Pub. No.: US 2024/0131606 A1
(43) Pub. Date: Apr. 25, 2024

(54) REAMING TOOL VACUUM ASSEMBLY

(71) Applicant: INTERNATIONAL BUSINESS MACHINES CORPORATION, ARMONK, NY (US)

(72) Inventors: PAUL SAMANIEGO, PORT EWEN, NY (US); DOUGLAS ALEXANDER SMALLEY, CLINTON CORNERS, NY (US); KARL OWEN CASSERLY, VALLEY STREAM, NY (US); ERIC MALLERY, EAST HARTFORD, CT (US); MATEUSZ KOZIOL, POUGHKEEPSIE, NY (US); ALFREDO FAPPIANO, TORRINGTON, CT (US); JAMES HOEY, NEW YORK, NY (US); OSWALD J. MANTILLA, DUTCHESS, NY (US); RYAN ELSASSER, POUGHKEEPSIE, NY (US)

(21) Appl. No.: 17/971,841

(22) Filed: Oct. 23, 2022

(51) Int. Cl. B23D 75/00

(52) U.S. Cl. CPC B23D 75/005; B23D 2277/28

(57) ABSTRACT

A reaming tool vacuum assembly comprising: a reaming tool comprising a reaming bit, the reaming bit comprising: a tip end; a base end; a plurality of flutes tapered toward the tip end; a plurality of apertures positioned between the plurality of flutes, wherein the plurality of apertures define a plurality of openings to an interior chamber of the reaming bit; a first rigid tube positioned in the interior chamber of the reaming bit, wherein the reaming bit is rotatable around a longitudinal axis of the first rigid tube and independent of the first rigid tube; and a vacuum to provide suction in the interior chamber of the reaming bit via the first rigid tube.

### BACKGROUND

### Field of the Invention

The field of the invention is a reamer tool, or more specifically a reamer tool with an integrated vacuum for debris collection.

### Description of Related Art

Screw fasteners are widely used throughout the manufacture of servers and specialized equipment. Occasionally, especially where there may be multiple usage of the same screw during maintenance or repair, a stripped screw hole condition may occur, and unless repaired, renders the system in an unsafe or unmaintainable condition. In the restricted environment of a computer room for example, traditional repair methods may be prohibitive. Traditional stripped screw hole repair entails methods that produce metal debris that may be harmful to equipment operation.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 shows an example view of a reaming tool vacuum assembly according to some embodiments of the present disclosure.

FIG. 2 shows an example view of a reaming tool vacuum assembly according to some embodiments of the present disclosure.

FIG. 3 an example view of a reaming tool of a reaming tool vacuum assembly according to some embodiments of the present disclosure.

FIG. 4 shows a flowchart of an example method of use for a reaming tool vacuum assembly according to some embodiments of the present disclosure.

FIG. 5 shows a flowchart of an example method of use for a reaming tool vacuum assembly according to some embodiments of the present disclosure.

### SUMMARY

A reaming tool vacuum assembly may include: a reaming tool comprising a reaming bit, the reaming bit comprising: a tip end; a base end; a plurality of flutes tapered toward the tip end; a plurality of apertures positioned between the plurality of flutes, wherein the plurality of apertures define a plurality of openings to an interior chamber of the reaming bit; a first rigid tube positioned in the interior chamber of the reaming bit, wherein the reaming bit is rotatable around a longitudinal axis of the first rigid tube independent of the first rigid tube; and a vacuum able to provide suction in the interior chamber of the reaming bit via the first rigid tube.

### DETAILED DESCRIPTION

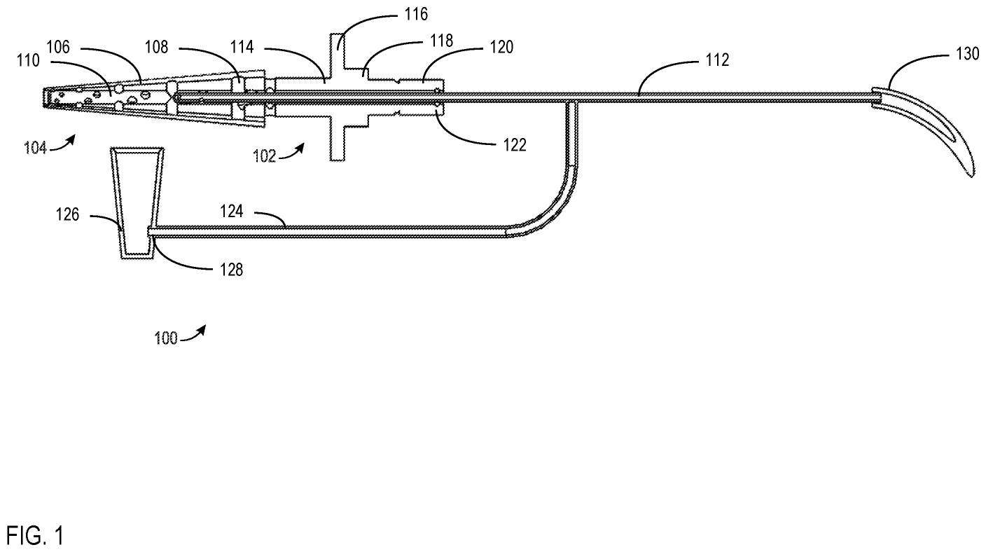

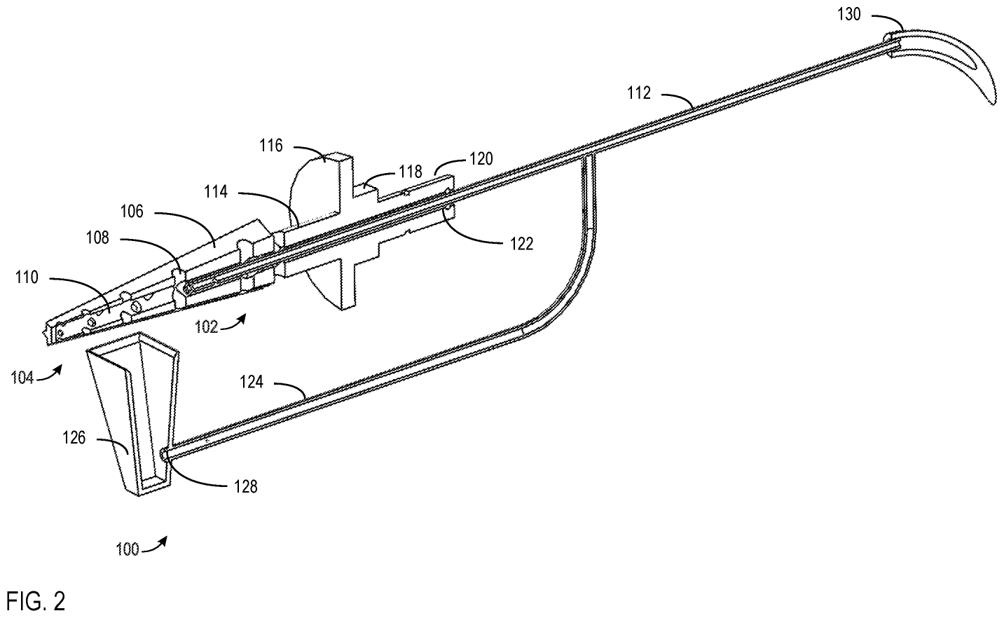

A reaming tool vacuum assembly in accordance with the present invention are described with reference to the accompanying drawings, beginning with FIG. 1. FIG. 1 shows an example cross-sectional view of a reaming tool vacuum assembly 100 according to some embodiments of the present disclosure. An isometric cross-sectional view of the reaming tool vacuum assembly 100 is also shown at FIG. 2. The reaming tool vacuum assembly 100 includes a reaming tool 102 including a reaming bit 104. Although the reaming tool 102 is described in the context of multiple parts or components, one skilled in the art will appreciate that, in some embodiments, the reaming tool 102 may be molded or manufactured as a single article. In other embodiments, the reaming tool 102 may be manufactured as multiple separate parts that are bonded together through welding or other bonding processes as can be appreciated.

The reaming bit 104 is composed of a hardened material such as metal. Particularly, the reaming bit 104 is composed of a material of greater hardness than a target material on which the reaming bit 104 is intended to be used. The reaming bit 104 includes multiple flutes 106 that, when the reaming tool 102 is rotated while the flutes 106 are in contact with the interior of a hole in a target material, cause the flutes 106 to scrape or remove debris from the interior of the hole, thereby smoothing or enlarging the hole. The reaming bit 104 is tapered from a base end to a tip end such that a diameter of the reaming bit 104 is smaller towards the tip end and larger towards the base end.

The reaming bit 104 also includes multiple apertures 108. The apertures 108 define openings into an interior chamber 110 of the reaming bit 104. The interior chamber 110 of the reaming bit 104 is closed at the tip end of the reaming bit 104 and open at the base end of the reaming bit 104 to allow suction of debris produced by reaming through the interior chamber 110 as will be described in further detail below. In some embodiments, the apertures 108 increase in size as they approach the base end of the reaming bit 104. That is, apertures 108 may be smaller towards the tip end of the reaming bit 104 and larger toward the base end of the reaming bit 104. In some embodiments, the apertures 108 may be positioned at regular intervals across a circumference of the reaming bit 104, such as every sixty degrees. In some embodiments, the apertures 108 are positioned between flutes 106 such that apertures 108 are defined at least partially in the bases of a pair of adjacent flutes 106.

A first rigid tube 112 is inserted into the reaming tool 102. The first rigid tube 112 is a tube of rigid or semi-rigid material such as metal, plastic, or other compounds or materials as can be appreciated. The first rigid tube 112 includes a hollow interior to allow for the passage of air and debris. The reaming tool 102 may be rotated independent of the first rigid tube 112 such that the first rigid tube 112 may remain in a relatively fixed position while the reaming tool 102 is rotated. In other words, the reaming tool 102 may be rotated to ream holes without requiring that the first rigid tube 112 also be rotated. For example, the reaming tool 102 may be rotated around a longitudinal axis of the first rigid tube 112. Accordingly, in some embodiments, the first rigid tube 112 is cylindrical or substantially cylindrical to allow for ease of rotation of the reaming tool 102.

The first rigid tube 112 is inserted into the reaming tool 102 such that the reaming tool 102 may move freely along the first rigid tube 112, thereby allowing the reaming bit 104 to move into greater depths of a hole. Accordingly, as the reaming tool 102 is positioned into varying depths, the first rigid tube 112 may be inserted at varying depths in the interior chamber 110. For example, the deeper the reaming bit 104 is in a target material the shallower the depth the first rigid tube 112 is inserted in the interior chamber 110.

In some embodiments, the first rigid tube 112 is of a substantially same circumference as the interior chamber 110. Thus, apertures 108 that are fully in contact with the first rigid tube 112 are substantially sealed, thereby prohibiting suction through those apertures 108. Referring to the example of FIGS. 1 and 2, the first rigid tube 112 is positioned approximately midway into the interior chamber 110. Accordingly, apertures 108 toward the tip end of the reaming bit 104 are open, allowing for suction of debris through those apertures 108. Apertures 108 toward the base end open into the surface of the first rigid tube 112 and are thereby substantially closed or sealed, thereby preventing air flow and loss of suction through these apertures 108.

The reaming tool vacuum assembly 100 may be coupled to a vacuum (not shown) such that suction is provided through the first rigid tube 112. As the reaming tool is rotated and debris is produced by the reaming bit 104, debris is suctioned through the opened apertures 108 (e.g., opened by virtue of not contacting or opening into the surface of the first rigid tube 112) into the interior chamber 110. The debris is then suctioned into the first rigid tube 112 into a vacuum for collection. Thus, debris that may potentially be difficult to otherwise collect and/or that may be potentially harmful to nearby electronics is removed from the reaming area.

In some embodiments, the reaming tool 102 includes a first body portion 114 extending or protruding from the base end of the reaming bit 104. For example, the first body portion 114 may include a cylindrical pipe, arm, and the like providing structural support and torque for the reaming tool 102 during rotation. In some embodiments the first body portion 114 may also include one or more apertures 108 defining an opening to an interior of the first body portion 114. The first body portion 114 contacts a first face of a backing plate 116. The backing plate 116 may be shaped as a circle or other geometric shape as can be appreciated. A wrench feature 118 may protrude from a second face of the backing plate 116. The wrench feature 118 may include a hexagonal structure, square structure, or other structure as can be appreciated to which a wrench may attach or grip. For example, a wrench may apply torque to the wrench feature 118 and pressure in the direction of the reaming bit 104 (and thus, a hole in a target material) on the backing plate 116, thereby allowing for the reaming tool 102 to be rotated and pressed into the hole in the target material.

A second body portion 120 may protrude from the wrench feature 118 to provide additional structural support for the first rigid tube 112. Thus, as shown, the first rigid tube 112 passes through an interior of the first body portion 114 and the second body portion 120 into the interior chamber 110 of the reaming bit 104. In some embodiments the second body portion 120 houses a swivel collar 122. The swivel collar 122 contacts the first rigid tube 112 and an interior of the second body portion. The swivel collar 122 allows for rotation of the reaming tool 102 around the longitudinal axis of the first rigid tube 112. In some embodiments, the swivel collar 122 includes an o-ring or other suitable seal for an interior of the reaming tool 102, thereby improving overall suction.

In some embodiments a second rigid tube 124 protruding from the first rigid tube 112. In some embodiments, a support arm (not shown) may contact the second rigid tube 124 at a horizontal and vertical portion of the second rigid tube 124 to provide additional support and to prevent additional bending or warping at the existing bend of the second rigid tube 124. In some embodiments a debris collector 126 is affixed to the second rigid tube 124. The debris collector 126 includes one or more sides, a bottom or base, and an open top. The debris collector 126 serves to collect any debris produced during the reaming process that was not suctioned into the interior chamber 110 of the reaming bit 104 via apertures 108. Accordingly, the debris collector 126 is aligned with the reaming bit 104 such that debris may fall downward into the debris collector 126.

In some embodiments, the debris collector 126 includes an aperture 128 defining an opening into an interior of the second rigid tube 124, thereby allowing the vacuum to provide suction into the debris collector 126. As shown, the aperture 128 is positioned in a side of the debris collector 126. However, in some embodiments, the aperture 128 may be positioned in other locations on the debris collector 126. For example, in some embodiments, the second rigid tube 124 may be closed at one end and the debris collector 126 may be affixed on the surface of the second rigid tube 124 such that the base of the debris collector 126 contacts the second rigid tube 124. In such an embodiment, the aperture 128 may instead be positioned at the base of the debris collector 126 and define the opening into the second rigid tube 124. One skilled in the art will appreciate that other configurations or placements of the aperture 128 are also contemplated within the scope of the present disclosure.

In some embodiments, an edge of the debris collector 126 may be substantially perpendicular to the first rigid tube 112, and therefore substantially perpendicular to a longitudinal axis of the reaming tool 102. Such an edge of the debris collector 126 may then be placed flush to the target material, assisting in stability and centering of the reaming tool 102.

Although the debris collector 126 is shown as having tapering sides and a flat base, one skilled in the art will appreciate that other shapes and configurations of the debris collector 126 are also contemplated within the scope of the present disclosure. For example, the debris collector 126 may include one or more non-tapering sides. As another example, the debris collector 126 may include one or more curved or non-straight sides.

In some embodiments, the debris collector 126 may be at least partially made of a magnetic material. As an example, a rim of the debris collector 126 may be made of magnetic material. The magnetic material attracts ferromagnetic debris that may be potentially harmful to electronic components and that may otherwise fall into the debris collector 126 for collection.

In some embodiments, the reaming tool vacuum assembly 100 may include a flexible hose 130 to couple the first rigid tube 112 to a vacuum. The flexible hose 130 is a sealed hose of flexible material such as rubber, flexible plastic, and the like that provides a seal between the vacuum and the first rigid tube 112. Thus, the flexible hose 130 will allow for free movement of the reaming tool vacuum assembly 100 without loss of suction.

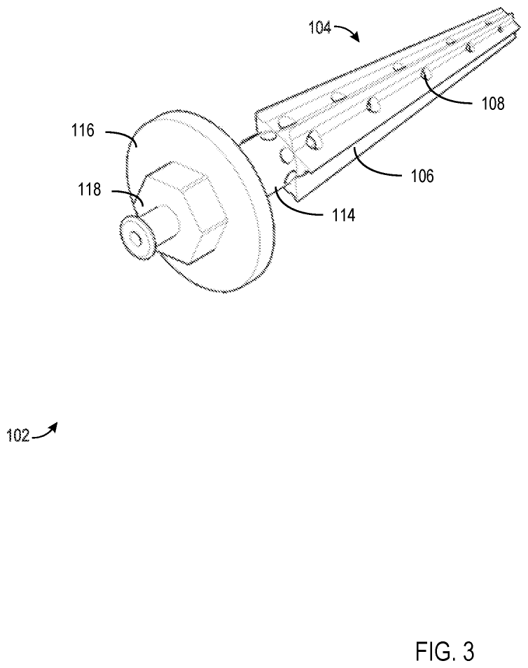

FIG. 3 shows another view of the reaming tool 102. Here, the placement of the apertures 108 is shown as being positioned between flutes 106 such that the openings are partially though two flutes 106. For example, an aperture 108 is positioned partially in a beveled edge of one flute 106 and an angled edge of another flue 106. Additionally, the view of the reaming tool 102 of FIG. 3 shows apertures 108 in the first body portion 114 (e.g., past the base end of the reaming bit 104) into an interior of the reaming tool 102.

The example view of the reaming tool 102 of FIG. 3 also shows the wrench feature 118 protruding from the back plate 116. Here, the wrench feature 118 is shown as a hexagonal feature. However, one skilled in the art will appreciate that, in other embodiments, other shapes of wrench features 118 may also be used depending on particular engineering and design considerations.

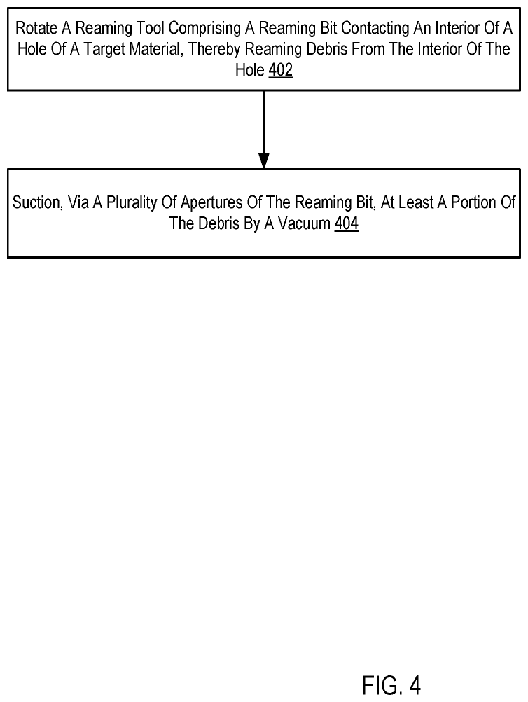

For further explanation, FIG. 4 shows a flowchart of an example method of use for a reaming tool vacuum assembly 100 according to some embodiments of the present disclosure. The method of FIG. 4 may be performed, for example, using the reaming tool vacuum assembly 100 as described in FIGS. 1-3. The method of FIG. 4 includes rotating 402 a reaming tool 102 comprising a reaming bit 104 contacting an interior of a hole of a target material, thereby reaming debris of the interior of the hole.

The reaming bit 104 contacts the interior of the hole of a target material in that the reaming bit 104 is at least partially inserted into the hole such that flutes 106 of the reaming bit 104, when the reaming bit 1o4 is rotated, scrape or ream portions of the target material from the hole, thereby smoothing and/or enlarging the hole. In some embodiments, the reaming tool 102 is rotated around a longitudinal access of a first rigid tube 112 inserted into an interior chamber 110 of the reaming bit 104. Accordingly, the reaming tool 102 has freedom of movement relative to the first rigid tube 112, thereby allowing the reaming tool 102 to be rotated independent of the first rigid tube 112. Moreover, the reaming tool 102 has freedom of movement along the longitudinal axis of the first rigid tube 112, allowing the first rigid tube 112 to be inserted at varying depths of the internal chamber 110 and allowing the reaming tool 102 to be inserted at varying depths of the hole without requiring movement or repositioning of the first rigid tube 112.

In some embodiments, the reaming tool 102 is rotated using a wrench feature 118. As an example, a wrench feature 118 such as a hexagonal wrench feature 118 may protrude from a backing plate 116. A wrench or similar tool may be used to apply rotational torque to the reaming tool 102 via the wrench feature 118 while applying forward pressure (e.g., towards the hole) against the backing plate 116. In some embodiments, rotating the reaming tool 102 may be assisted or facilitated by a swivel collar 122.

The method of FIG. 4 also includes suctioning 404, by a plurality of apertures 108 of the reaming bit 104, at least a portion of the debris by a vacuum. The vacuum may be coupled to the first rigid tube 112 via a flexible hose 130 or other pressure-sealed connector. Suction is provided to a tip of the first rigid tube 112 such that suction occurs via the exposed apertures 108 in the reaming bit 104. The exposed apertures 108 are those apertures 108 at least partially opened or exposed by virtue of the first rigid tube 112 not being inserted at a depth past those apertures 108.

Accordingly, as the reaming tool 102 is rotated, debris is removed via the flutes 106. Portions of this debris is suctioned into the exposed apertures 108 into the inner chamber 110, and then suctioned into the vacuum via the first rigid tube 112. Thus, the debris produced by reaming is suctioned away during the reaming process, reducing the amount of debris that may potentially harm surrounding components such as electronic components.

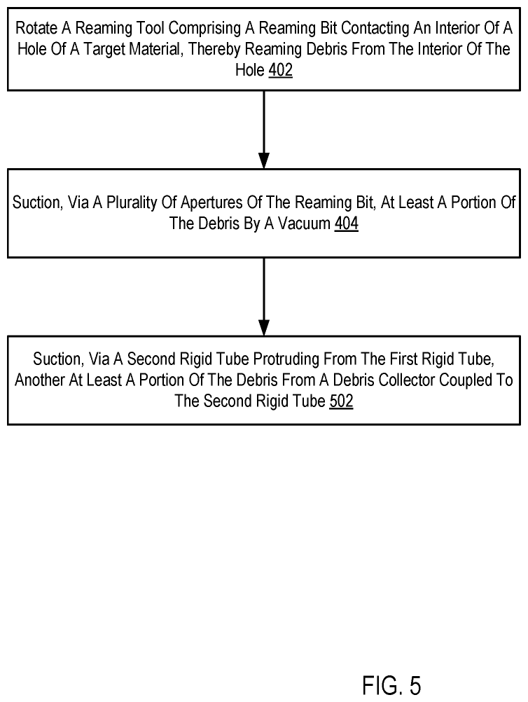

For further explanation, FIG. 5 shows a flowchart of an example method of use for a reaming tool vacuum assembly 100 according to some embodiments of the present disclosure. The method of FIG. 5 is similar to FIG. 4 in that the method of FIG. 5 includes rotating 402 a reaming tool 102 comprising a reaming bit 104 contacting an interior of a hole of a target material, thereby reaming debris of the interior of the hole; and suctioning 404, by a plurality of apertures 108 of the reaming bit 104, at least a portion of the debris by a vacuum.

The method of FIG. 5 differs from FIG. 4 in that the method of FIG. 5 includes suctioning 502, via a second rigid tube 124 protruding from the first rigid tube 112, another at least a portion of the debris from a debris collector 126 coupled to the second rigid tube 124. The debris collector 126 includes one or more sides, a bottom or base, and an open top. The debris collector 126 serves to collect any debris produced during the reaming process that was not suctioned into the interior chamber 110 of the reaming bit 104 via apertures 108. Accordingly, the debris collector 126 is aligned with the reaming bit 104 such that debris may fall downward into the debris collector 126.

In some embodiments, debris is suctioned from the debris collector 126 by an aperture 128 defining an opening into an interior of the second rigid tube 124. For example, in embodiments where the debris collector 126 is mounted at an end of the second rigid tube 124, the aperture 128 may be located in a side of the debris collector 126. As another example, where the debris collector 126 is mounted on the second rigid tube (e.g., on an exterior surface), the aperture 128 may be positioned in a base of the debris collector 126. In some embodiments, at least a portion of the debris collector 126 may be made of a magnetic material. For example, the rim of the debris collector 126 may be made of magnetic material. Thus, ferromagnetic debris will be attracted to the debris collector 126, further reducing the amount of debris not contained using the reaming tool vacuum assembly 100.

In view of the explanations set forth above, readers will recognize that the benefits of a reaming tool vacuum assembly according to embodiments of the present invention include:
Improved removal of reaming debris via vacuum suction through apertures in a reaming bit.
Improved removal of reaming debris using a debris collector positioned below a reaming bit and also coupled to the vacuum.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A reaming tool vacuum assembly comprising:
a reaming tool comprising a reaming bit, the reaming bit comprising:
a tip end;
a base end;
a plurality of flutes tapered toward the tip end;
a plurality of apertures positioned between the plurality of flutes, wherein the plurality of apertures define a plurality of openings to an interior chamber of the reaming bit;
a first rigid tube positioned in the interior chamber of the reaming bit, wherein the reaming bit is rotatable around a longitudinal axis of the first rigid tube and independent of the first rigid tube; and
a vacuum to provide suction in the interior chamber of the reaming bit via the first rigid tube.

2. The reaming tool vacuum assembly of claim 1, further comprising:
a second rigid tube protruding from the first rigid tube at an aperture in the first rigid tube; and
a debris collector affixed to the second rigid tube and aligned with the reaming bit, wherein the debris collector comprises an aperture defining an opening into an interior of the second rigid tube, thereby allowing the vacuum to provide suction into the debris collector.

3. The reaming tool vacuum assembly of claim 2, wherein the debris collector comprises at least a portion of magnetic material.

4. The reaming tool vacuum assembly of claim 3, wherein a rim of the debris collector is composed of the magnetic material.

5. The reaming tool vacuum assembly of claim 2, wherein the aperture defining the opening into the interior of the second rigid tube is positioned at a base of the debris collector.

6. The reaming tool vacuum assembly of claim 2, wherein the aperture defining the opening into the interior of the second rigid tube is positioned at a side of the debris collector.

7. The reaming tool vacuum assembly of claim 2, wherein an edge of a side of the debris collector is substantially perpendicular relative to the first rigid tube.

8. The reaming tool vacuum assembly of claim 7, wherein the side of the debris collector is substantially perpendicular relative to the first rigid tube.

9. The reaming tool vacuum assembly of claim 1, wherein the reaming tool further comprises:
a first body portion extending from the base end of the reaming bit; and
a backing plate having a first face contacting the first body portion and a second face having a wrench feature.

10. The reaming tool vacuum assembly of claim 9, wherein the reaming tool further comprises a second body feature protruding from the wrench feature, wherein the second body feature comprises a swivel collar positioned at an interior of the second body feature, wherein the first rigid tube passes through the swivel collar, thereby allowing the reaming tool to be rotated independent of the first rigid tube.

11. The reaming tool vacuum assembly of claim 1, further comprising a flexible hose coupled to the first rigid tube and the vacuum.

12. The reaming tool vacuum assembly of claim 1, wherein each of the plurality of apertures increases in size approaching the base end of the reaming bit.

13. The reaming tool vacuum assembly of claim 1, wherein the first rigid tube is of a substantially same diameter as the interior chamber of the reaming bit, thereby allowing one or more of the apertures of the reaming bit to be sealed based on a depth of insertion of the first rigid tube in the reaming bit.

14. A method of use for a reaming tool vacuum assembly comprising:
rotating a reaming tool comprising a reaming bit contacting an interior of a hole of a target material, thereby reaming debris from the interior of the hole; and
suctioning, via a plurality of apertures of the reaming bit, at least a portion of the debris by a vacuum.

15. The method of claim 14, wherein suction is applied to an interior of the reaming bit by the vacuum via a first rigid tube at least partially inserted into the reaming bit.

16. The method of claim 15, the reaming tool is rotated around a longitudinal axis of the first rigid tube, independent of the first rigid tube.

17. The method of claim 14, wherein the reaming tool is rotated by torque applied to a wrench feature of the reaming tool.

18. The method of claim 14, wherein each of the plurality of apertures increases in size approaching a base end of the reaming bit.

19. The method of claim 15, further comprising suctioning, via a second rigid tube protruding from the first rigid tube, another at least a portion of the debris from a debris collector coupled to the second rigid tube.

20. The method of claim 19, wherein the debris collector comprises a portion of magnetic material.
